(19) United States
(12) Patent Application Publication
(10) Pub. No.: US 2013/0343052 A1
(43) Pub. Date: Dec. 26, 2013

(54) LED light for a ceiling fan

(71) Applicant: Teng-Chia Yen, Changhua (TW)

(72) Inventor: Teng-Chia Yen, Changhua (TW)

(21) Appl. No.: 13/531,614

(22) Filed: Jun. 25, 2012

(51) Int. Cl. F21V 1/00; F21V 29/00

(52) U.S. Cl. 362/235

(57) ABSTRACT

A light fixture is provided with a metal light seat including four inclined sides on a bottom, and a plurality of heat sinks disposed along four sides of a top; a plurality of LED arrays disposed on the bottom of the light seat, each LED array including a plurality of LEDs disposed thereon; and a lampshade complimentarily secured to the light seat. At least one LED array is in proximity to the heat sinks.

### BACKGROUND OF THE INVENTION

1. Field of the Invention

The invention relates to light-emitting diode (LED) lights and more particularly to an LED light fixture for mounting to a ceiling fan.

2. Description of Related Art

Ceiling fans are quite common in businesses, such as restaurants, lounges, retail stores, places of assembly, personal residences, etc. Ceiling fans are installed to aid in the movement of air to keep the environment more comfortable.

A typical ceiling fan A is shown in FIG. 1 and comprises a plurality of fan blades A1. A typical lamp B is attached to the ceiling fan A from below and comprises a plurality of light bulbs B1.

However, a drawback has been found in the typical ceiling fan and lamp combination. In detail, hot air rather than cold air is blown downward because high heat generated by the light bulbs B1 is driven downward by the air flows produced by the fan blades A1. Thus, people may feel warm rather than cool when staying in the room installed with the ceiling fan and lamp combination.

Thus, the need for improvement still exists.

### SUMMARY OF THE INVENTION

It is therefore one object of the invention to provide a light fixture comprising a metal light seat comprising four inclined sides on a bottom, and a plurality of heat sinks disposed along four sides of a top; a plurality of LED arrays disposed on the bottom of the light seat, each LED array comprising a plurality of LEDs disposed thereon; and a lampshade complimentarily secured to the light seat; wherein at least one of the LED arrays is in proximity to the heat sinks.

The above and other objects, features and advantages of the invention will become apparent from the following detailed description taken with the accompanying drawings.

### BRIEF DESCRIPTION OF THE DRAWINGS

FIG. 1 is a perspective view of a typical ceiling fan and lamp combination;

FIG. 2 is an exploded view of an LED light according to the invention;

FIG. 3 is a perspective view of the assembled light seat;

FIG. 4 is a broken away interior view of the assembled LED light;

FIG. 5 is a perspective view of the LED light mounted to a typical ceiling fan from below; and

FIG. 6 is a longitudinal sectional view of the LED light shown in FIG. 5.

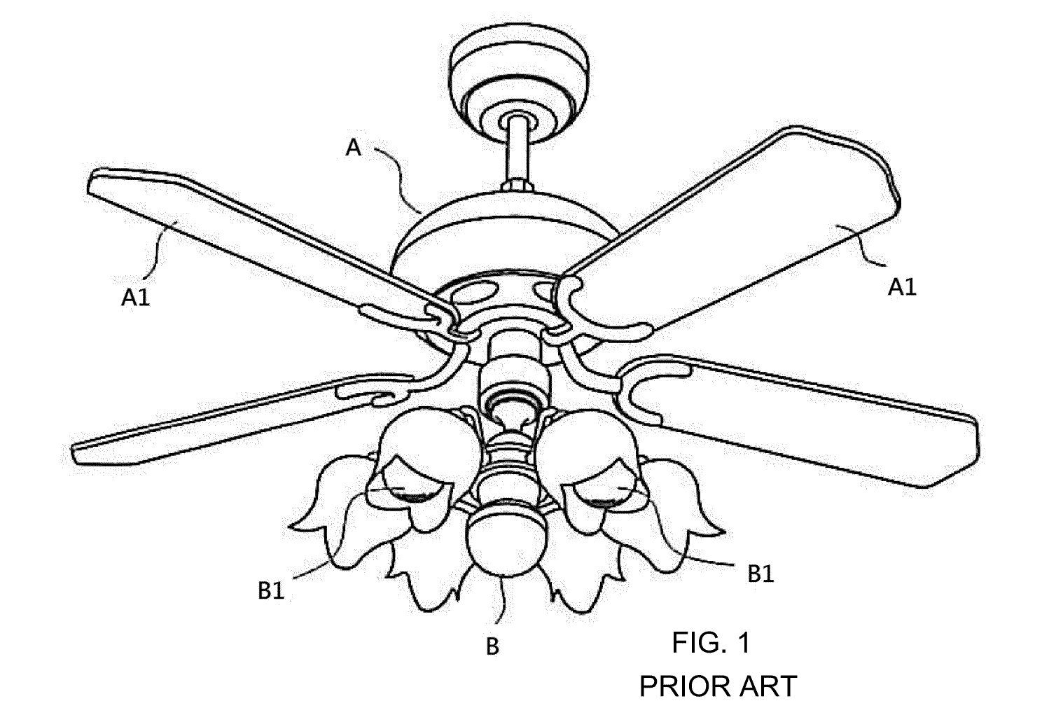

### DETAILED DESCRIPTION OF THE INVENTION

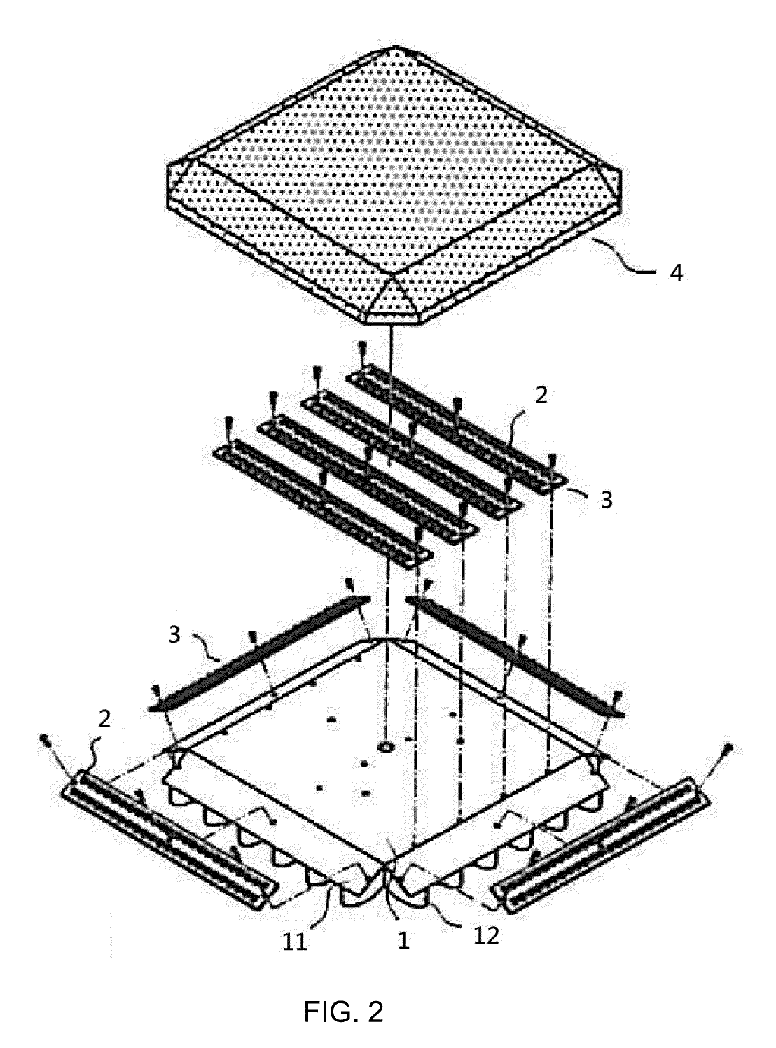

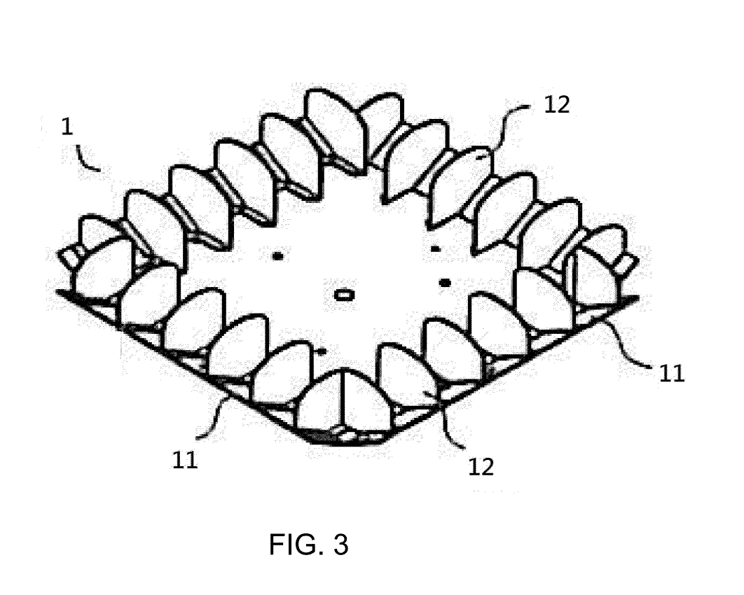

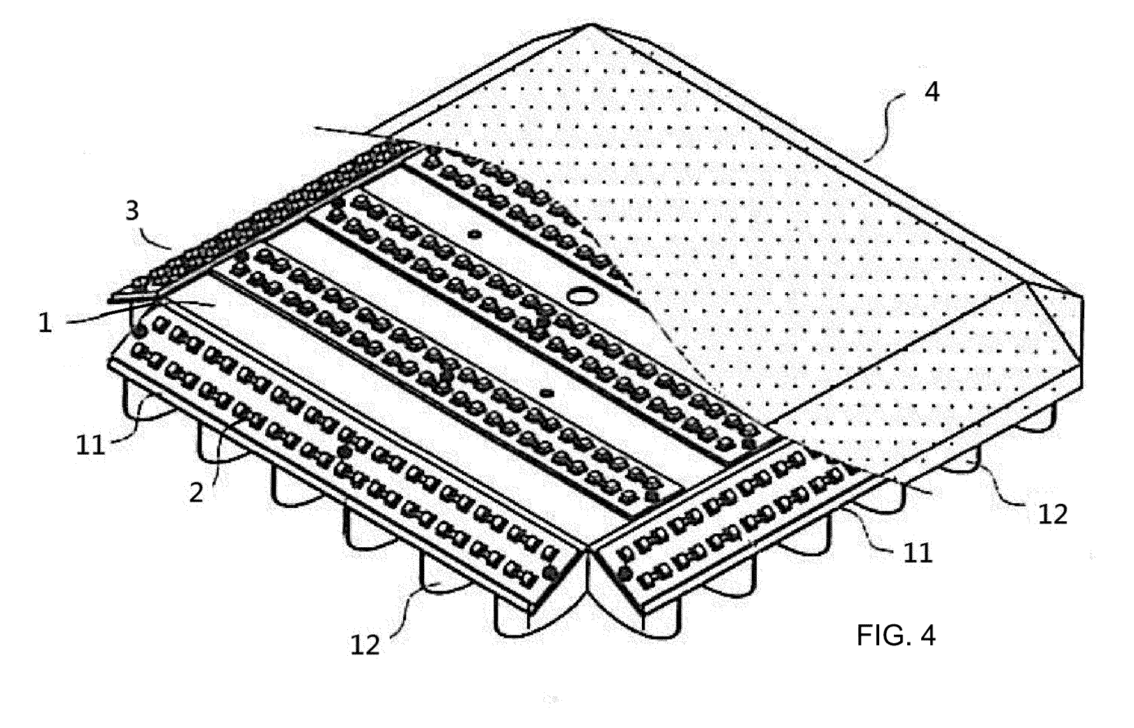

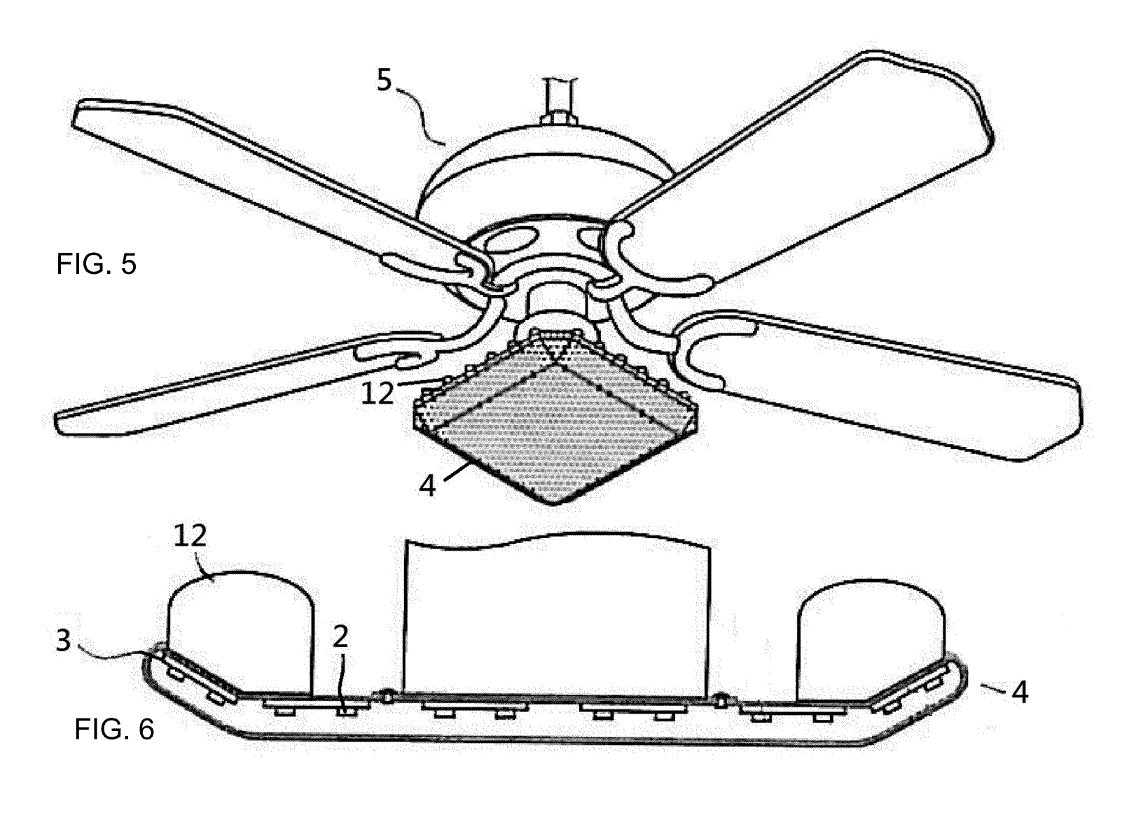

Referring to FIGS. 2 to 6, an LED light for mounting to a ceiling fan 5 in accordance with the invention comprises the following components as discussed in detail below.

A rectangular light seat 1 is made of metal and comprises four inclined sides 11 on a bottom, and a plurality of heat sinks 12 arranged along four sides of a top.

A plurality of LEDs 2 are electrically connected to an AC to DC adaptor (not shown) which is in turn electrically connected to an external power source (e.g., 120V wall outlet).

A plurality of LED arrays 3 are shaped as an oblong plates and each LED array 3 is provided with the LEDs 2 thereon. Four of the LED arrays 3 are spaced in parallel on the portion of the bottom of the light seat 1. The remaining four LED arrays 3 are disposed along the four sides of the light seat 1 and in close proximity to the heat sinks 12 so that heat generated by the LEDs 2 can be quickly, effectively dissipated by the heat sinks 12 (see FIG. 6).

A rectangular lampshade 4 is made of acrylic or the like and is complimentarily secured to the light seat 1.

While the invention has been described in terms of preferred embodiments, those skilled in the art will recognize that the invention can be practiced with modifications within the spirit and scope of the appended claims.

What is claimed is:

1. A light fixture comprising:
a metal light seat comprising four inclined sides on a bottom, and a plurality of heat sinks disposed along four sides of a top;
a plurality of LED arrays disposed on the bottom of the light seat, each LED array comprising a plurality of LEDs disposed thereon; and
a lampshade complimentarily secured to the light seat;
wherein at least one of the LED arrays is in proximity to the heat sinks.
